(19) United States
(12) Patent Application Publication
(10) Pub. No.: US 2012/0121309 A1
(43) Pub. Date: May 17, 2012

(54) COSMETIC APPLICATOR WITH VIBRATION DEVICE

(75) Inventor: LI-MEI LIU, TAIPEI COUNTY (TW)

(73) Assignee: CHUEN CHERN CO., LTD., TAIPEI COUNTY (TW)

(21) Appl. No.: 12/944,071

(22) Filed: Nov. 11, 2010

(51) Int. Cl. A46B 5/02; B43K 29/00

(52) U.S. Cl. 401/6; 401/195

(57) ABSTRACT

A cosmetic applicator includes an application assembly comprising a non-rigid container including an upper opening, a neck adjacent thereto, and a reservoir for storing a liquid cosmetic; and a massaging mechanism; and a vibration mechanism mounted to an outer surface of the container by securing to the neck and a lower portion of the container. The cosmetic applicator can provide a user with a pleasing “feel” when rubbed against the skin with the dispensed lotion and when the vibration mechanism activates.

### BACKGROUND OF THE INVENTION

1. Field of Invention

The invention relates to cosmetic applicators and more particularly to a cosmetic applicator having a vibration device mounted onto a container so as to provide a user with a pleasing “feel” when rubbed against the skin with the dispensed lotion and when the vibration device activates.

2. Description of Related Art

A typical type of cosmetic applicator comprises a container filled with lotion and having an open top, a bottle cap releasably mounted on the container, and a roller rotatably retained at the open top. A user may squeeze the container and rotate the roller to dispense lotion. Also, the rolling roller can provide the user with a somewhat good “feel” when rubbed against the skin of the user.

However, the conventional cosmetic applicator is not provided with a vibrator. Thus, it does not have a massaging effect for user. Moreover, it is not leak-proof. Lotion may leak via the surface of the roller if the container is squeezed unintentionally by an object. Further, it is difficult of precisely controlling the amount of lotion being dispensed. All of above may bring inconvenience to users. Thus, the need for improvement still exists.

### SUMMARY OF THE INVENTION

It is therefore one object of the invention to provide a cosmetic applicator comprising an application assembly comprising a non-rigid container including an upper opening, a neck adjacent thereto, and a reservoir for storing a liquid cosmetic; and a massaging mechanism; and a vibration mechanism mounted to an outer surface of the container by securing to the neck and a lower portion of the container.

The above and other objects, features and advantages of the invention will become apparent from the following detailed description taken with the accompanying drawings.

### BRIEF DESCRIPTION OF THE DRAWINGS

FIG. 1 is an exploded view of a cosmetic applicator according to a first preferred embodiment of the invention;

FIG. 2 is a longitudinal sectional view of the assembled cosmetic applicator; with the bottle cap removed;

FIG. 3 is a fragmentary view of an upper portion of the cosmetic applicator of FIG. 2;

FIG. 4 is a view similar to FIG. 3 showing lotion being dispensed after removing the bottle cap while the vibration assembly is activated;

FIG. 5 is a perspective view of the cosmetic applicator;

FIG. 6 is a perspective view of the cosmetic applicator according to a second preferred embodiment of the invention; and

FIG. 7 is a perspective view of the cosmetic applicator according to a third preferred embodiment of the invention.

### DETAILED DESCRIPTION OF THE INVENTION

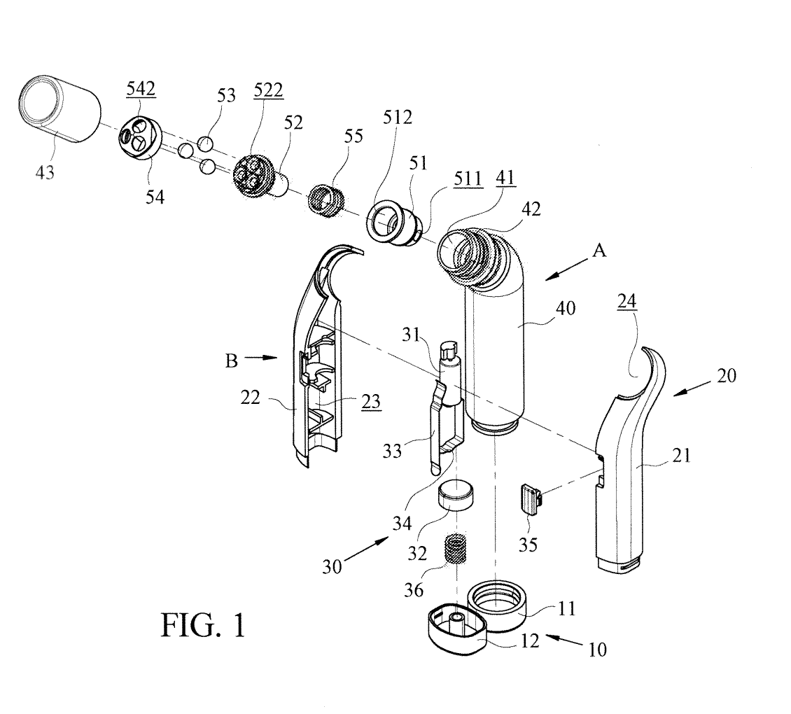

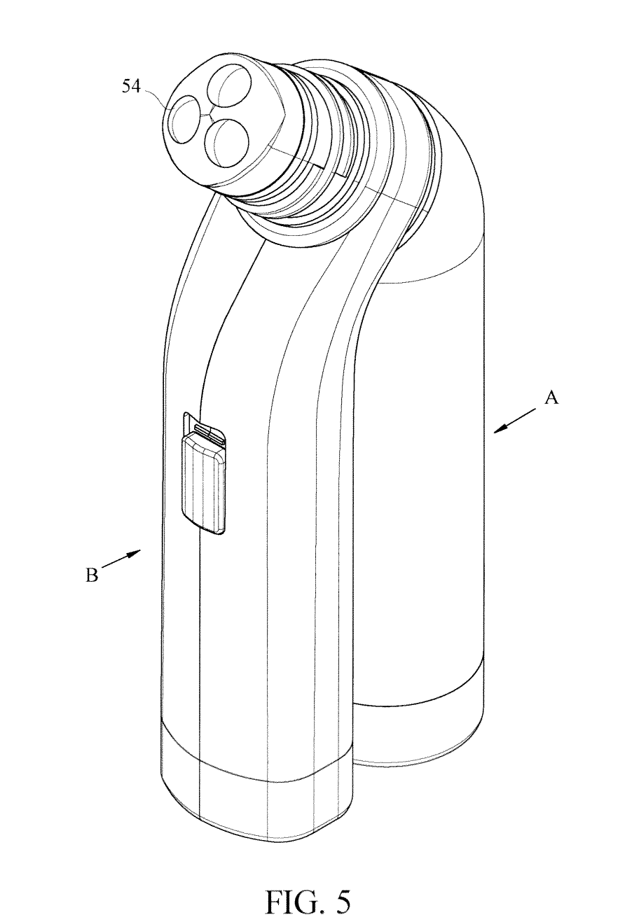

Referring to FIGS. 1 to 5, a cosmetic applicator in accordance with a first preferred embodiment of the invention comprises the following components as discussed in detail below.

An application assembly A comprises a container 40 made of plastic and adapted to be flexibly squeezed by the hand, the container 40 including an upper opening, a neck adjacent thereto, and a reservoir for storing a liquid cosmetic (e.g., lotion, skin-care cream, gel, etc.); and a massaging mechanism 50.

A vibration mechanism B is mounted to an outer surface of the container 40 by securing to the neck and lower portion of the container 40.

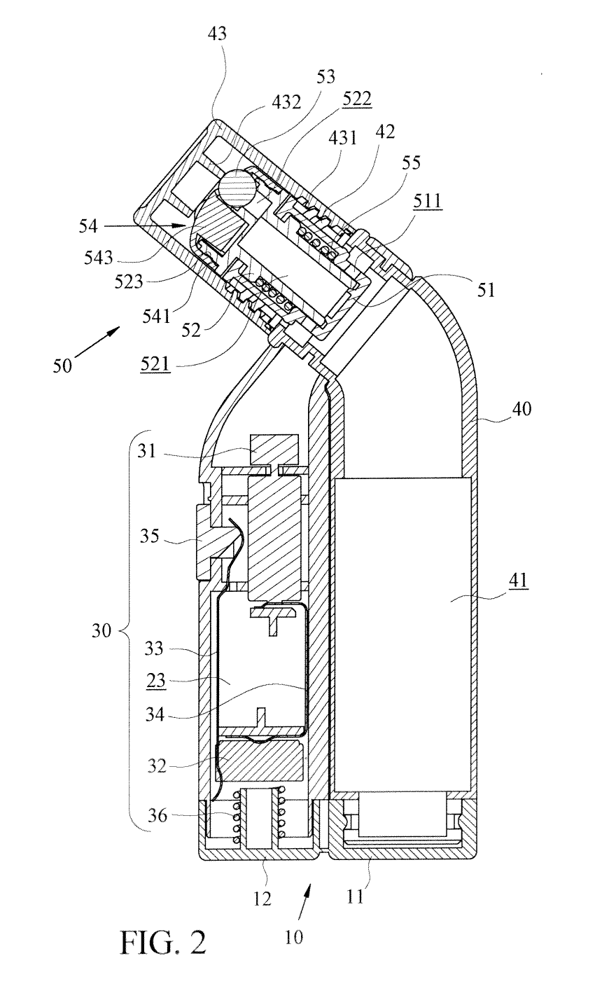

The massaging mechanism 50 is mounted in the opening and neck of the container 40 and comprises a cup 51, a moveable member 52, a plurality of (e.g., three) plastic balls 53, a massaging head 54, and a torsion spring 55. The cup 51 comprises a plurality of inlet openings (e.g., two opposite inlet openings being shown in FIG. 2) 511 on a lower portion, and an internal space 512 communicating with the inlet openings 511. The moveable member 52 comprises a hollow 521 in a shank portion of reduced diameter, three outlet openings 522 on a head portion with the balls 53 rotatably seated thereon, and external threads 523 around the head portion. The spring 55 is put on the shank portion of the moveable member 52 and together they are disposed in the space 512. The massaging head 54 is a substantially hollow cylinder and comprises a plurality of (e.g., three) equally spaced circular holes 542 on a convex head adapted to retain the balls 53 which are partially projected out of the holes 542, internal threads 541 on an inner, annular surface adapted to secure to the external threads 523 so as to fasten the massaging head 54 and the moveable member 52 together, and a plurality of spacers 543 extending downward from bottom of the convex head to engage with the head portion of the moveable member 52 so that the balls 53 can rotate freely.

It is noted that the number of the balls 53 may be in the range of one (1) to ten (10) and the number of the balls 53 is three (3) is simply an exemplary example for the sake of description.

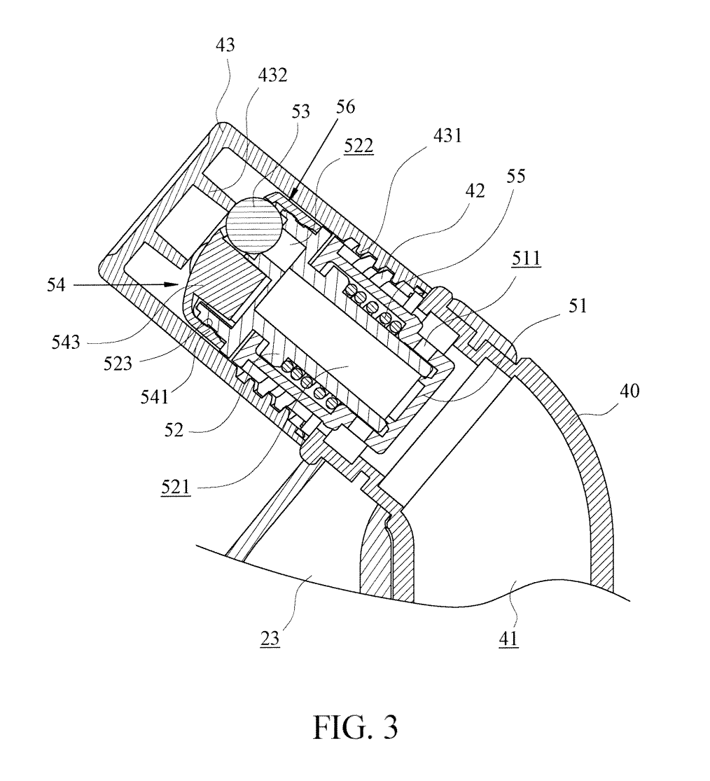

The container 40 comprises an internal space 41 having an upper opening, an externally threaded extension 42 on a neck, and a cylindrical bottle cap 43 comprising a threaded section 431 formed on an inner, annular surface and adapted to secure to the externally threaded section 42 to fasten the bottle cap 43 and the container 40 together. The bottle cap 43 further comprises a protrusion 432 extending from bottom of its top toward its opening to push and urge against the massaging head 54 so that the massaging mechanism 50 can be held in a spring energized position with elastic force being stored (i.e., the moveable member 52 being pushed down and the spring 55 being compressed as shown in FIGS. 2 and 3). Also, the inlet openings 511 are blocked by the moveable member 52 in this inoperative position.

The vibration mechanism B comprises a housing 20 including a first shell 21 and a second shell 22 together with the first shell 21 forming the housing 20, the housing having a receiving space 23 and an upper opening 24 for retaining the neck of the container 40; and a vibration assembly 30 disposed in the space 23.

An integral seat 10 comprises a hollow cylindrical member 11 secured to a downward extending open bottom of the container 40 for closing by snapping, and a hollow member 12 having a bossed hole on a bottom.

The vibration assembly 30 comprises a DC (direct current) motor 31, an electric battery 32 disposed rearward of the DC motor 31, and a coil spring 36 put on the bossed hole of the hollow member 12 which retains the engaged first and second shells 21, 22. The vibration assembly 30 further comprises a first electrode 33 extending from a contact with a moveable switch 35 to a negative pole of the battery 32, and a second electrode 34 extending from the bottom of the DC motor 31 to engage with a positive pole of the battery 32 due to the urging force of the spring 55 against the battery 32. The switch 35 is mounted on the outer surface of the housing 20. A manual movement of the switch 35 can electrically connect the battery 32 to the DC motor 31 for supplying power thereto (i.e., closing an electrical circuit). This means that the switch 35 is normally off. Thus, the DC motor 31 may activate to vibrate the housing 20 and the cosmetic applicator as detailed later. It is also understood that an opposite manual movement of the switch 35 can open the electrical circuit (i.e., deactivating the DC motor 31).

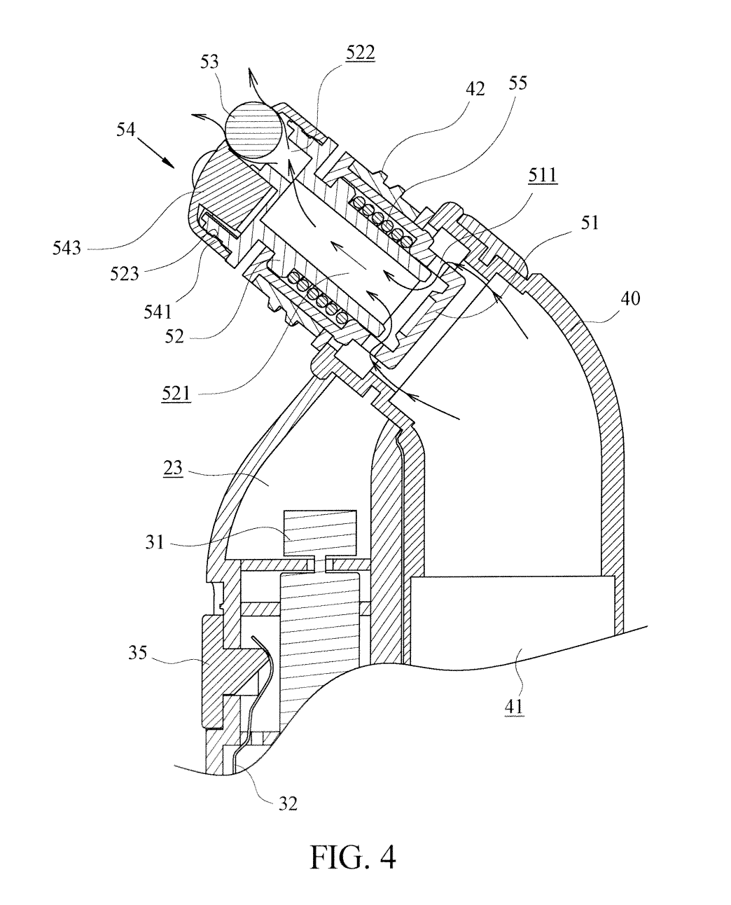

Operations of the invention are described in detailed below. First, a user may move the switch 35 to an on position in order to activate the DC motor 31 for generating vibration. Next, the user may remove the bottle cap 43 to disengage the protrusion 432 from the massaging head 54 so as to release the elastic energy stored in the massaging mechanism 50. That is, the spring 55 expands to push the moveable member 52 toward the massaging head 54 until being stopped (see FIG. 4). At the same time, the moveable member 52 clears the inlet openings 511. Next, the user may slightly squeeze the container 40 to cause lotion in the space 41 to flow to the space 512 via the inlet openings 511. And in turn, the lotion flows to the undersides of the balls 53 via the hollow 521. Next, the user may rotate the balls 53 to rub the skin of the user with the lotion being dispensed via the surfaces of the balls 53. Thus, the vibrating effect of the massaging head 54 may provide a pleasing “feel” to the user. Advantageously, the lotion consumption is reduced to a minimum while being effective.

After use, the user may move the switch 35 to an off position and then return the bottle cap 43 to the cosmetic applicator with the massaging mechanism 50 being closed and pushed down. Thus, the massaging mechanism 50 is disposed in a position with the spring 55 being compressed and elastic force being stored in the spring 55 (i.e., the moveable member 52 being pushed down). Also, the inlet openings 511 are blocked by the moveable member 52 as a result of the movement of the moveable member 52 away from the massaging head 54. This has the advantage of preventing lotion from being dispensed due to an unintentional squeeze of the container 40 (i.e., being leak-proof).

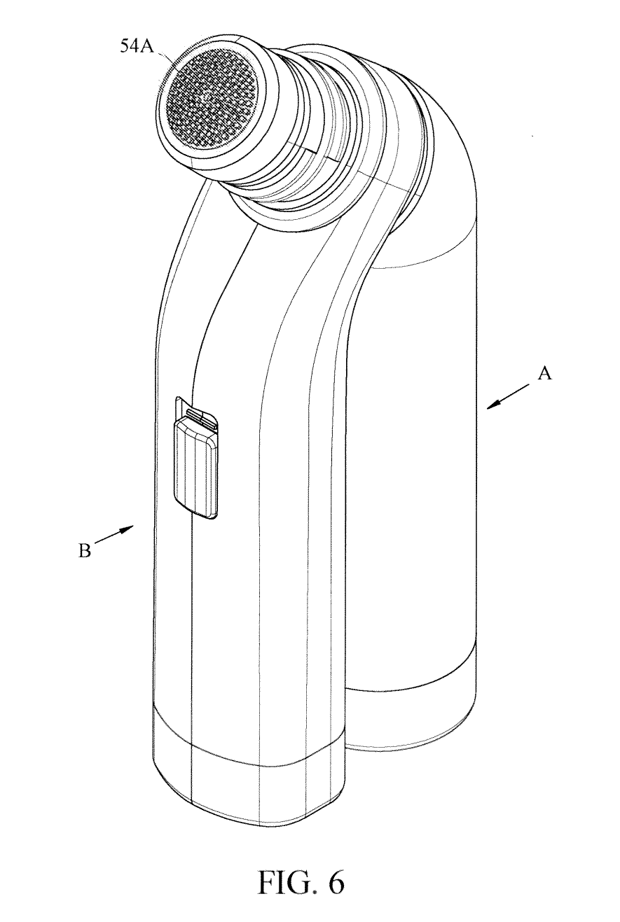

Referring to FIG. 6, the cosmetic applicator in accordance with a second preferred embodiment of the invention is shown. The second preferred embodiment is substantially the same as the first preferred embodiment except the balls of the massaging head are replaced with a plurality of (e.g., hundreds) balls as massaging means 54A formed on the head of the massaging head.

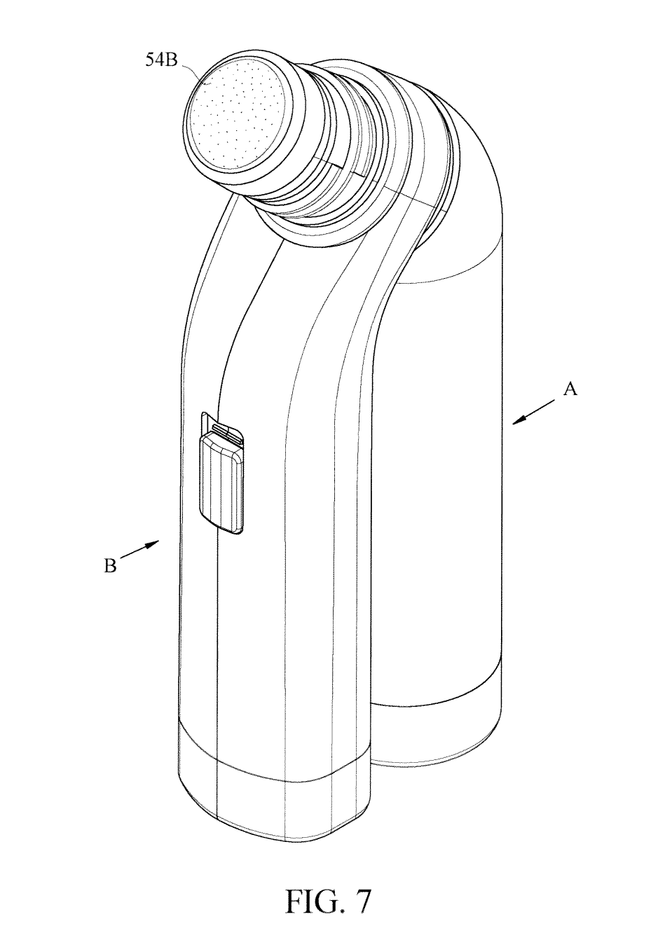

Referring to FIG. 7, the cosmetic applicator in accordance with a third preferred embodiment of the invention is shown. The third preferred embodiment is substantially the same as the first preferred embodiment except the balls of the massaging head are replaced with a sponge member as massaging means 54B mounted on the head of the massaging head.

While the invention has been described in terms of preferred embodiments, those skilled in the art will recognize that the invention can be practiced with modifications within the spirit and scope of the appended claims.

What is claimed is:

1. A cosmetic applicator comprising:
an application assembly comprising a non-rigid container including an upper opening, a neck adjacent thereto, and a reservoir for storing a liquid cosmetic; and a massaging mechanism; and
a vibration mechanism mounted to an outer surface of the container by securing to the neck and a lower portion of the container.

2. The cosmetic applicator of claim 1, wherein the massaging mechanism is mounted in both the opening and the neck of the container and comprises a cup, a moveable member, at least one plastic ball, a massaging head, and a torsion spring, and wherein the cup comprises at least one inlet opening on a lower portion, and an internal space communicating with the at least one inlet openings, the moveable member comprises a hollow in a shank portion, at least one outlet opening on a head portion with the at least one ball rotatably seated thereon, and first external threads around the head portion, the spring is put on the shank portion of the moveable member and together they are disposed in the space of the cup, and the massaging head is a substantially hollow cylinder and comprises at least one hole on a head adapted to retain the at least one ball each being partially projected out of the hole, first internal threads on an annular inner surface adapted to secure to the first external threads to fasten the massaging head and the moveable member together, and at least one spacer extending downward from a bottom of the head to engage with the head portion of the moveable member so that the at least one ball can rotate freely.

3. The cosmetic applicator of claim 2, wherein the container further comprises second external threads on the neck, and a cylindrical bottle cap including second internal threads on the annular inner surface and adapted to secure to the second external threads to fasten the bottle cap and the container together, and a protrusion extending from a bottom of its top to push and urge against the massaging head in an inoperative position of the cosmetic applicator so that the massaging mechanism can be held in a spring energized position with the moveable member being pushed down to block the at least one opening and the torsion spring being compressed.

4. The cosmetic applicator of claim 2, wherein the at least one ball comprises one ball or two, three, four, five, six, seven, eight, nine, or ten balls.

5. The cosmetic applicator of claim 2, wherein the at least one ball comprises hundreds balls.

6. The cosmetic applicator of claim 2, wherein the at least one ball is replaced by a sponge member.

7. The cosmetic applicator of claim 1, wherein the vibration mechanism comprises a housing including a receiving space and an upper opening for retaining the neck of the container; and a vibration assembly disposed in the space of the housing.

8. The cosmetic applicator of claim 7, wherein the housing further includes a first shell and a second shell together with the first shell forming the housing.

9. The cosmetic applicator of claim 7, further comprising an integral seat including a hollow cylindrical member secured to the lower portion of the container for closing a bottom of the container, and a hollow member secured to the engaged first and second shells.

10. The cosmetic applicator of claim 9, wherein the vibration assembly comprises a DC (direct current) motor, an electric battery disposed rearward of the DC motor, a coil spring anchored in the hollow member to urge against the battery, a moveable switch mounted on an outer surface of the housing, a first electrode extending from the switch to a negative pole of the battery, and a second electrode extending from the DC motor to engage with a positive pole of the battery; and wherein the switch is manually moveable between on and off position and electrically connects the battery to the DC motor for generating vibration when in the on position.
